(19) United States
(12) Patent Application Publication
(10) Pub. No.: US 2006/0237515 A1
(43) Pub. Date: Oct. 26, 2006

(54) Exothermic weld mold clamp

(75) Inventor: Rodd R. Ruland, Amherst, NH (US)

Correspondence Address: HARRINGTON & SMITH, LLP, 4 RESEARCH DRIVE, SHELTON, CT, 06484-6212, US

(73) Assignee: FCI Americas Technology, Inc.

(21) Appl. No.: 11/112,329

(22) Filed: Apr. 22, 2005

(51) Int. Cl. B23K 37/00

(52) U.S. Cl. 228/44.3

(57) ABSTRACT

An exothermic weld mold clamp including a mold locating system adapted to locate pieces of an exothermic mold relative to each other; and a mold locking system. The mold locking system includes at least one mold locking pin movably mounted on the mold locating system and a spring biasing the locking pin towards a locking position with at least one of the exothermic mold pieces.

### BACKGROUND OF THE INVENTION

1. Field of the Invention

The invention relates to an exothermic weld mold clamp and, more particularly, to a mold locking system.

2. Brief Description of Prior Developments

U.S. Pat. No. 6,382,496 B1 discloses an exothermic welding handle clamp. Currently, mold clamps are used to hold pieces of a multi-piece exothermic weld mold together in order for them to be secured together during an exothermic welding process. A conventional mold clamp or handle clamp uses threaded thumb screws which are manually tightened or screwed into the mold pieces to clamp the mold pieces to the mold clamp. The process of screwing the thumb screws into the mold pieces is a very time intensive process. It is the single longest step during an entire exothermic welding process including screwing the thumb screws into place, and then unscrewing the thumb screws after the weld installation.

There is a desire for a faster method for installing and removing an exothermic mold on a mold clamp, and a system for accomplishing this faster installation and removal.

### SUMMARY OF THE INVENTION

An exothermic weld mold clamp can be provided for clamping mold pieces of an exothermic mold together. The pieces can be locked on the clamp by spring loaded pins which are longitudinally slidable into holes of the mold pieces. The pins do not need to be screwed into the mold pieces and do not need to be screwed through a threaded connection being moved on the clamp.

In accordance with one aspect of the invention; an exothermic weld mold clamp is provided including a mold locating system adapted to locate pieces of an exothermic mold relative to each other; and a mold locking system. The mold locking system includes at least one mold locking pin movably mounted on the mold locating system and a spring biasing the locking pin towards a locking position with at least one of the exothermic mold pieces.

In accordance with another aspect of the invention, an exothermic weld mold clamp is provided comprising a mold locating system adapted to locate pieces of an exothermic mold relative to each other; and a mold locking system comprising at least one mold locking pin longitudinally slidably mounted on a flange of the mold locating system and a spring biasing the locking pin towards a locking position with at least one of the exothermic mold pieces. The mold locking pin comprises a keying section and the flange comprises a keying hole such that the keying section of the pin and the keying hole cooperate to allow locking of the mold locking pin in at least one longitudinal position on the flange.

In accordance with one method of the invention, a method of connecting an exothermic mold to an exothermic weld mold clamp comprising steps of locating the exothermic mold in a mold locating system of the exothermic weld mold clamp; longitudinally sliding a mold locking pin of a mold locking system of the exothermic weld mold clamp into a hole in a mold piece of the exothermic mold; and biasing the mold locking pin against the mold piece by a spring.

### BRIEF DESCRIPTION OF THE DRAWINGS

The foregoing aspects and other features of the invention are explained in the following description, taken in connection with the accompanying drawings, wherein:

FIG. 1 is a perspective view of a conventional exothermic weld mold clamp;

FIG. 2 is a perspective view of the clamp shown in FIG. 1 having mold pieces of an exothermic mold attached thereto;

FIG. 3 is an exploded perspective view of portions of an exothermic weld mold clamp incorporating features of the invention;

FIG. 4 is a perspective view showing the spring and spring clamp on the locking pin shown in FIG. 3;

FIG. 5 is a partial perspective view of portions of the clamp shown in FIG. 3 without the locking pin for illustrative purposes only;

FIG. 6 is a cross sectional view of locking system on one side of the clamp shown in FIGS. 3-5;

FIG. 7 is a cross sectional view as in FIG. 6 showing the locking system engaging one of the mold pieces and in a locked position; and

FIG. 8 is a cross sectional view of an alternate embodiment showing the locking pin locked in an outward unlocked position.

### DETAILED DESCRIPTION OF THE PREFERRED EMBODIMENTS

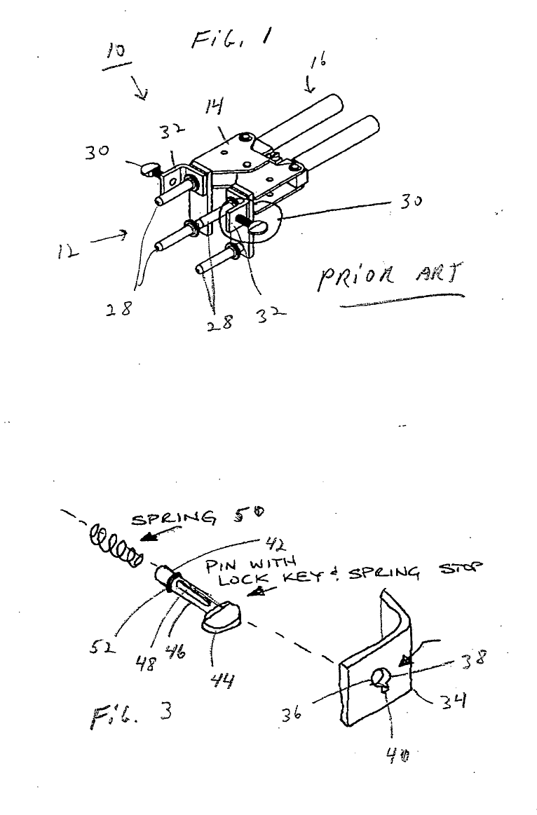

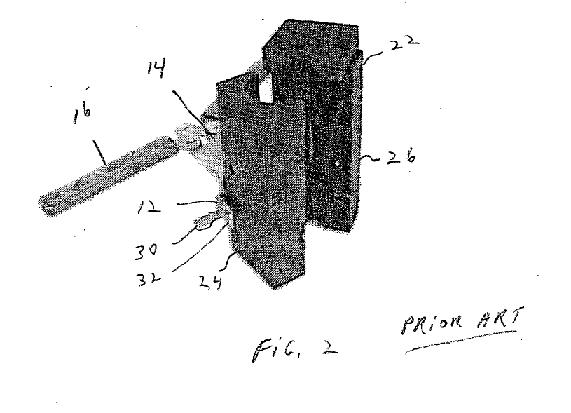

Referring to FIG. 1, there is shown a perspective view of a conventional exothermic weld mold clamp 10. The clamp 10 comprises an exothermic mold mounting section 12, a movement section 14, and a rear handle section 16. The mold mounting section 12 comprises a left section 18 and a right section 20. Each section 18, 20 is adapted to have a mold piece of an exothermic mold separately mounted thereto. Referring also to FIG. 2, the clamp 10 is shown attached to an exothermic mold 22. The movement section 14 is adapted to move the left and right sections 18, 20 relative to each other to move the mold pieces 24, 26 between an open position as shown in FIG. 2 and a closed position relative to each other. Other types of clamps are known in the art. The description of the invention with reference to the clamp shown in FIGS. 1 and 2 is for illustrative purposes only, and should not be considered as limiting to the invention.

Each side section 18, 20 of the mold mounting section 12 generally comprises a locating system comprising forward cantilevered pins 28. Each side section 18, 20 of the mold mounting section 12 also comprise a mold locking system comprising a mold locking screw or bolt 30, such as a thumb screw, threaded in a hole of a lateral side flange 32. The locating pins 28 are slid into holes in the mold pieces 24, 26 at the rear sides of the mold pieces. The bolts 30 are then screwed into threaded holes in the lateral sides of the mold pieces to lock the mold pieces 24, 26 to each respective side section 18, 20.

The threaded thumb screws 30 are manually tightened or screwed into the mold pieces 24, 26 to clamp the mold pieces to the mold clamp. The process of screwing the thumb screws into the mold pieces is a very time intensive process. It is the single longest step during an entire exothermic welding process including screwing the thumb screws into place and then unscrewing the thumb screws after the weld installation.

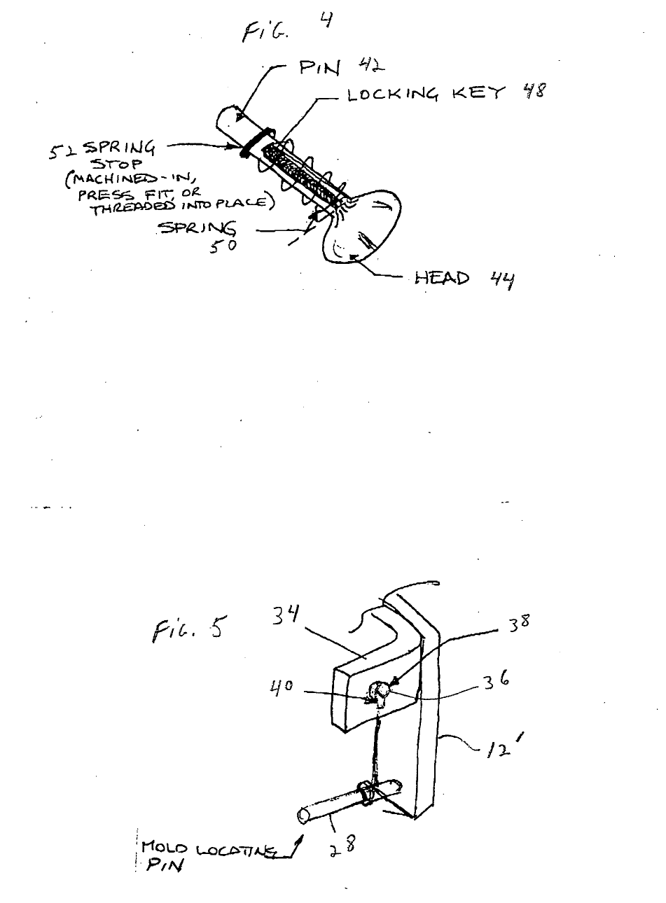

Referring now to FIGS. 3-5, one embodiment of the invention will be described. Although the invention will be described with reference to the exemplary embodiments shown in the drawings, it should be understood that the invention can be embodied in many alternate forms of embodiments. In addition, any suitable size, shape or type of elements or materials could be used.

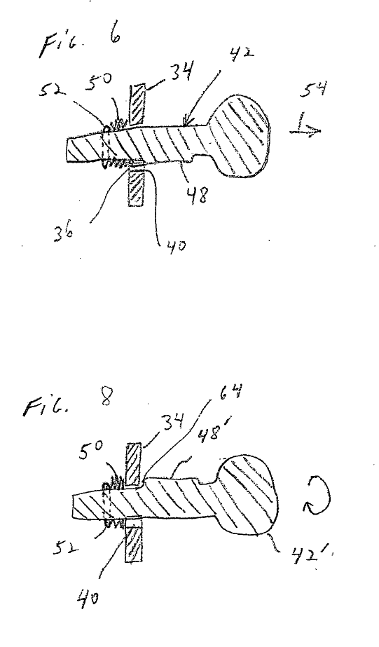

FIG. 3 shows parts of a mold locking system, for use with the clamp shown in FIG. 1, to replace the thumb screws 30 and flanges 32 and thereby create a new exothermic weld mold clamp incorporating features of the invention. FIG. 5 shows one of the modified side sections of the mold mounting section 12′. The flange 34 is identical to the flange 32 except for the hole 36. The hole 36 is not a threaded hole. Instead, the hole 36 comprises a keyed slot with a main section 38 and a key section 40. The flange 34 is located at the same position relative to the locating pins 28 as in the conventional clamp 10, or perhaps in a further laterally outward position.

Instead of the two thumb screws 30, the invention comprises the two locking pins 42 which replace the thumb screws. Each locking pin 42 comprises a head or thumb section 44, a main shaft 46, and a key section 48. The locking pins 42 form spring loaded wing-nut pins, which are not threaded into the dies or the flange, adapted to be assembled to the mold clamp wing (flange) to create a spring load in compression. Instead of time intensive threading and loosening operation, as with a conventional system, the user can simple pull the heads of the pins 42, insert the mold, and release the head sections 44. This is a considerable savings of time and effort, decreasing connector installation cost and speeding job completion.

Mounted to the main shaft 46 is a coil spring 50 and a spring retainer 52. The spring retainer 52 retains the spring 50 on the main shaft 46. The spring retainer could be machined in, press fit, or threaded into place for example. The main shaft 46 is slidably located in the main section 38 of the hole 36 in a respective one of the flanges 34. The thumb section 44 is located at the exterior side of the flange 34. The spring retainer 52 is located at the interior side of the flange 34. The spring 50 has opposite ends located against the spring retainer 52 and the flange 34, respectively, such the spring 50 biases the locking pin 42 in an inward direction. The thumb section 44 acts as a stop to stop inward movement of the locking pin 42 on the flange 34.

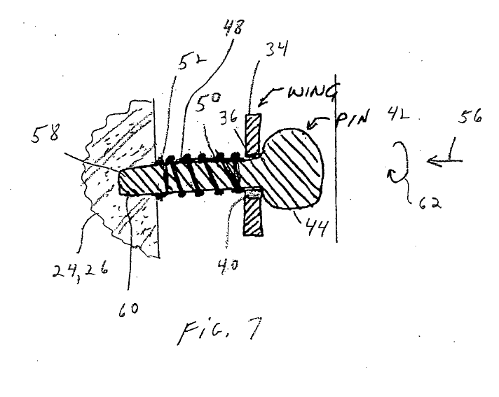

As seen with reference to FIG. 6, the locking pin 42 can be pulled outward as indicated by arrow 54. When the locking pin is pulled outward, the spring 50 can be compressed between the spring retainer 52 and the interior side of the flange 34. The key section 48 is able to slide in the key section 40 of the hole 36. Outward locating of the locking pins 42 allows the mold pieces 24, 26 (see FIG. 2) to be inserted into the mold mounting section 12′ and onto the locating pins 28. Referring also to FIG. 7, after the mold pieces 24, 26 are properly positioned on the mold clamp, the user can release the thumb sections 44. The spring 50 biases the locking pin 42 into a locking position as shown by arrow 56 with the front end 58 of the pin projecting into a respective receiving hole 60 of each of the mold pieces 24, 26. The hole 60 does not need to be threaded. However, if the hole is threaded, the front end of the pin could be adapted to be inserted into the threaded hole without being threaded into the threads. The user can then axially rotate the pin 42, as indicated by arrow 62, to rotate the key section 48 out of registry with the key section 40 of the hole 36. This results in the longitudinal position of the locking pin 42 being fixed relative to the flange 34 and the mold piece 24 or 26. Hence, the pin 42 is prevented from longitudinal movement and can lock the mold piece to the mold clamp without screwing the pin into the mold piece.

After an exothermic welding process has occurred, to remove the mold pieces from the mold clamp, the pin 42 can be rotated as indicated by arrow 62 to return the key section 48 into registration with the key section 40 of the hole 36. The user can then pull the pin 42 out of engagement with the mold piece as indicated by arrow 54 in FIG. 6. With the mold piece no longer locked to the mold clamp, the mold piece can be slid off of the locating pins 28.

Referring also to FIG. 8, an alternate embodiment of the invention is shown. In this embodiment the locking pin 42′ has a notch 64 at the front end of the key section 48′ which allows the locking pin to be locked in an outward unlocked position as shown. This could make insertion and removal of the mold pieces onto their final positions on the locating pins 28 easier because the user can contain the locking pins in the open position by locating the locking key 48′ away from keyway 40 in hole 36. Thus, the user does not need to hold the locking pins in an open position manually during insertion and removal of the mold pieces.

In one type of alternate embodiment, the locking pins could be longitudinally slidably mounted to the flanges, but their tips could be configured to be screwed into the holes of the mold pieces. Thus, this could provide fast longitudinal movement of the front tips of the pins into the holes, but still provide a threaded engagement with the mold pieces. In another type of alternate embodiment, the rear end of the shaft could be threaded between the keying section and the head. The flange could have a threaded section in the hole wherein the threads at the rear end of the shaft would only be threaded into the threaded hole of the flange at the end of inward longitudinal movement of the pin. A combination of these two alternatives could also be provided. The middle section of the pin, however, would still be longitudinally slidable in the hole of the flange.

With the invention an exothermic weld mold clamp can be provided comprising a mold locating system and a mold locking system. The mold locating system is adapted to locate pieces of an exothermic mold relative to each other. The mold locking system can comprise a mold locking pin movably mounted on the mold locating system and a spring biasing the pin towards a locking position with the mold piece. In another alternate embodiment the key sections 40 and 48 might not be provided, or alternatively, any suitable locking system for locking the locking pins at inward or outward positions on the flange could be provided.

It should be understood that the foregoing description is only illustrative of the invention. Various alternatives and modifications can be devised by those skilled in the art without departing from the invention. Accordingly, the invention is intended to embrace all such alternatives, modifications and variances.

1. An exothermic weld mold clamp comprising:
a mold locating system adapted to locate pieces of an exothermic mold relative to each other; and
a mold locking system comprising at least one mold locking pin movably mounted on the mold locating system and a spring biasing the locking pin towards a locking position with at least one of the exothermic mold pieces.

2. An exothermic weld mold clamp as in claim 1 wherein the at least one mold locking pin is longitudinally slidably mounted to a side flange of the mold locating system.

3. An exothermic weld mold clamp as in claim 1 wherein the at least one mold locking pin comprises two mold locking pins biased in opposite directions towards each other.

4. An exothermic weld mold clamp as in claim 1 wherein the mold locking system comprises a system for locking longitudinal position of the locking pin relative to the mold locating system in the locking position.

5. An exothermic weld mold clamp as in claim 1 wherein the mold locking system comprises a system for locking longitudinal position of the locking pin relative to the mold locating system in an unlocked outward position.

6. An exothermic weld mold clamp as in claim 1 wherein the at least one mold locking pin comprises a keying section for limiting movement of the locking pin relative to a hole through a flange of the mold locating system.

7. An exothermic weld mold clamp as in claim 1 wherein the spring comprises a coil spring mounted around a section of the at least one mold locking pin.

8. An exothermic weld mold clamp as in claim 7 wherein the spring is located against an inward facing side of a locking pin mounting flange of the mold locating system.

9. An exothermic weld mold clamp comprising:
a mold locating system adapted to locate pieces of an exothermic mold relative to each other; and
a mold locking system comprising at least one mold locking pin longitudinally slidably mounted on a flange of the mold locating system and a spring biasing the locking pin towards a locking position with at least one of the exothermic mold pieces, wherein the mold locking pin comprises a keying section and the flange comprises a keying hole such that the keying section of the pin and the keying hole cooperate to allow locking of the mold locking pin in at least one longitudinal position on the flange.

10. An exothermic weld mold clamp as in claim 9 wherein the at least one mold locking pin comprises two mold locking pins biased in opposite directions towards each other.

11. An exothermic weld mold clamp as in claim 9 wherein the at least one longitudinal position comprises an unlocked outward position.

12. An exothermic weld mold clamp as in claim 9 wherein the at least one longitudinal position comprises a locked inward position with a tip of the at least one locking pin extending into a hole of one of the pieces of the exothermic mold.

13. An exothermic weld mold clamp as in claim 9 wherein the spring comprises a coil spring mounted around a section of the at least one mold locking pin.

14. An exothermic weld mold clamp as in claim 13 wherein the spring is located against an inward facing side of the flange of the mold locating system.

15. A method of connecting an exothermic mold to an exothermic weld mold clamp comprising steps of:
locating the exothermic mold in a mold locating system of the exothermic weld mold clamp;
longitudinally sliding a mold locking pin of a mold locking system of the exothermic weld mold clamp into a hole in a mold piece of the exothermic mold; and
biasing the mold locking pin against the mold piece by a spring.

16. A method as in claim 15 further comprising locking the mold locking pin in an outward unlocked position before locating the exothermic mold in the mold locating system and unlocking the mold locking pin from the outward unlocked position after locating the exothermic mold in the mold locating system.

17. A method as in claim 15 further comprising locking the mold locking pin in an inward locked position after the mold locking pin is slid into the hole.

18. A method as in claim 15 wherein the step of longitudinally sliding comprises a keying section of the mold locking pin longitudinally sliding in a keyed hole of the mold locating system.

19. A method as in claim 18 further comprising axially rotating the mold locking pin to lock and unlock the mold locking pin relative to the mold locating system.
